(19) United States
(12) Patent Application Publication
(10) Pub. No.: US 2020/0032501 A1
(43) Pub. Date: Jan. 30, 2020

(54) MONITORING ACCESS COVER

(71) Applicant: Drainage Management Services Limited, Llangernyw, Abergele (GB)

(72) Inventor: Andrew Charles BROOKSBANK, Llangernyw, Abergele (GB)

(21) Appl. No.: 16/603,223

(22) PCT Filed: Apr. 9, 2018
(86) PCT No.: PCT/GB18/50934

§ 371 Date: Oct. 5, 2019

(30) Foreign Application Priority Data
Apr. 11, 2017 (GB) 1705792.8

(51) Int. Cl. E03F 5/06; E03F 5/042; E03F 5/04; E03F 7/00; G01F 23/26; G01F 15/06; H04W 4/38

(52) U.S. Cl. CPC E03F 5/06; E03F 5/042; E03F 5/0404; E03F 7/00; E03F 2201/40; G01F 15/063; H04W 4/38; E03F 2005/066; G01F 23/268

(57) ABSTRACT

The access cover includes one or more sensors disposed at the underside thereof to measure the height of the water and/or sediment in a drain gully.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a monitoring access cover or grate. In particular, this invention relates to an intelligent access cover or grate for use, particularly, but not exclusively, with roadside surface water drains and gullies. The present invention enabling the level of the water and/or sediment in the drain gully beneath the access cover to be continually monitored in real time or near real time.

### 2. Description of Related Art Including Information Disclosed Under 37 CFR 1.97 and 37 CFR 1.98

It is a problem with roadside surface water drains, kerb drains and gullies that debris, litter and other solid material can accumulate over time in the gully cup to such an extent that in the event of even moderate rainfall, the outflow to the sewer water system can become completely, or partially, blocked, restricting flow into the sewer water system and causing localised flooding.

It is known to address the problem of litter, debris, sediment and silt accumulation in roadside surface water drains and gullies by utilising a mobile service operative or team of operatives to clean and otherwise maintain the drainage asset. The service team usually utilise a custom tanker vehicle to regularly inspect and remove the access cover, remove any debris inside the gully cup by suction and/or otherwise clean inside the gully cup to ensure that any surface water entering gully cup can subsequently flow into the sewer water system without restriction.

This type of service operation requires significant resources and capital investment at a time when many local and regional councils and bodies are faced with increasingly tighter budgets. In addition, over recent years, it has become clear that climate change does affect rainfall and other forms of precipitation as, fundamentally, a warmer climate allows the atmosphere to hold more moisture which, in turn, leads to more torrential rain storms. The effects of climate change, coupled with increasingly restrictive budgetary pressures, have therefore created a unique set of problems for those tasked with maintaining a network of roadside drainage assets, not only in the United Kingdom but also in many countries of the world.

It is an object of the present invention to provide monitoring access cover or grate and its method of use which overcomes or reduces the drawbacks associated with known products of this type. It is an object of the present invention to provide an access cover or grate that is positioned over a drain gully and which can be used to monitor the level of the water and/or sediment in the drain gully. The sensed level of water and/or sediment in the drain gully is transmitted continuously or intermittently, in real time, or near real time, for the purposes of service, repair, cleaning and/or flood warning. The transmitted data can be used to more efficiently and proactively manage the drainage assets of a sewer system network. It is a further object of the present invention to provide additional sensors and transducers disposed on the access cover that sense data representative of one or more environmental conditions and/or sensed parameters and/or other asset conditions. Localised information is gathered for dynamic and/or preventative action, reports and warning, such as, for example, total or partial removal of the access cover from the drain gully by vandals or by theft, and/or for warning when localised temperatures are sufficiently low enough to justify road gritting, etc. It is a further object of the present invention to provide an access cover or grate being dimensioned as a retrofit product, or as a new installation with a complementary-shaped surround.

### BRIEF SUMMARY OF THE INVENTION

The present invention is described herein and in the claims.

According to the present invention there is provided an access cover or grate comprising one or more sensors disposed at the underside thereof to measure the height of the water and/or sediment in a drain gully.

An advantage of the present invention is that by monitoring the height of the water and/or sediment in the drain gully, the cleaning and/or maintenance of the drainage asset can be managed more efficiently; saving costs, resources and manpower.

Preferably, the drain gully is a roadside surface water gully.

Further preferably, the drain gully forms at least part of a household or domestic water drainage system.

In use, the drain gully may form at least part of a tank or vessel.

Preferably, the access cover comprises:
a generally flat top surface and a spaced apart bottom surface;
a pair of side walls which extend between the top and bottom surfaces;
a pair of end walls which extend between the top and bottom surfaces; and
a plurality of apertures disposed in the top surface and the bottom surface, and through which water can pass.

Further preferably, the access cover is formed having a generally rectangular-shape in plan view and in use is positioned in a generally horizontal configuration with the top surface being uppermost.

In use, the plurality of apertures may be formed as two aligned rows of elongate apertures positioned between the side walls.

Preferably, the two aligned rows of elongate apertures form or define a central longitudinal rib positioned between the end walls.

Further preferably, the side walls and end walls are inclined inwardly towards the underside of the access cover, such that the access cover can be received and retained with a close fit inside a surround fixed above the drain gully.

In use, the access cover and/or surround may be formed using injection moulding tools and/or processes.

Preferably, the access cover and/or the surround is formed from homo- or copolymer polypropylene, or polyamide.

Further preferably, the access cover and/or the surround is formed from a synthetic plastics material and/or a thermoplastic and/or thermoset material and/or from a blend of recycled polymers from both postindustrial and domestic waste streams.

In use, the blend of recycled polymers may be at least 50% by weight of the plastics material.

Preferably, the access cover and/or the surround is formed via or blow moulding and/or vacuum forming and/or rotational moulding and/or compression moulding and/or rim moulding and/or powder impression moulding and/or any form of plastics manufacture.

Further preferably, the access cover and/or the surround is formed from cast iron.

In use, the access cover and/or the surround may be manufactured in accordance with European Standard EN 124:1994.

Preferably, the one or more sensors are disposed along the central longitudinal rib at the underside of the access cover.

Further preferably, the one or more sensors comprises a proximity sensor which, in use, faces downwardly into the drain gully and which generates an output signal based on the height of the water in the drain gully.

In use, the one or more sensors may comprise a water sensor which, in use, generates an output signal when the height of the water in the drain gully physically contacts the water sensor.

Preferably, the one or more sensors comprises an infrared sensor which, in use, faces downwardly into the drain gully and which generates an output signal based on the level of sediment or silt in the drain gully.

Further preferably, the one or more sensors is selected from the group consisting of photodiode, photoresistor, photodetector, resistance temperature detector, thermocouple, thermistor, piezoelectric, potentiometer, strain gauge, air flow sensor, anemometer, microphone, proximity sensor, motion sensor, Hall effect sensor, accelerometer, ultrasonic sensor, GPS tracker.

In use, the one or more sensors may be sealed inside ingress protected enclosures.

Preferably, the access cover further comprising:
a battery disposed in the underside of the access cover; and
processing and communications module for transmitting the sensed output signals.

Further preferably, the processing and communications module is implemented as a low power microcontroller.

In use, the processing and communications module may receive a wake-up signal from physical movement of the access cover and/or a rapid or marked change in the height of the water and/or sediment in the drain gully and/or by a remote user action.

Preferably, the sensed output signal from the one or more sensors is transmitted continuously or intermittently, in real time, or near real time, to a central processing means that also receives data from a further plurality of access covers in a sewer system network.

Further preferably, the access cover further comprising server means for sharing the received data with one or more remote computing devices over a network.

In use, the remote computing device may comprise a user interface for displaying and/or consuming the processed data.

Preferably, the central processing means comprises associated backend software.

Further preferably, the remote computing device is selected from the group consisting, but not limited to, any one of the following: tablet computer, smartphone, handheld computer, personal digital assistant, media player, desktop computer, notebook, virtual reality headset, smart watch, smart TV, any other digital media consumption device and the like.

In use, the server means may connect to the remote computing device via the Internet and/or Wi-Fi (IEEE 802.11 standard) and/or Bluetooth and/or LoRa and/or Sigfox and/or a cellular telecommunications network and/or via a wired connection.

Also according to the present invention there is provided a method of remotely monitoring a drain gully, comprising the steps of:
providing an access cover or grate comprising one or more sensors disposed at the underside thereof to measure the height of the water and/or sediment in a drain gully;
allocating a unique identifier to the access cover;
monitoring the height of the water and/or sediment in the drain gully;
communicating the measured height of the water and/or sediment to a central server; and
providing user access to the central server.

Further according to the present invention there is provided a system to monitor a drain gully, comprising:
central server means;
a uniquely identifiable remote sensing device disposed on an access cover including a processing means for receiving one or more sensed outputs representative of one or more environmental conditions and/or asset conditions; and
user interface means in wireless communication with the central server means, the user interface means being operable by a user for displaying the one or more sensed outputs.

It is believed that an access cover or grate and its method of use in accordance with the present invention at least addresses the problems outlined above.

It will be obvious to those skilled in the art that variations of the present invention are possible and it is intended that the present invention may be used other than as specifically described herein.

### BRIEF DESCRIPTION OF THE SEVERAL VIEWS OF THE DRAWINGS

The present invention will now be described by way of example only, and with reference to the accompanying drawings.

FIG. 1 is a perspective view from the side and above of a monitoring access cover or grate in accordance with the present invention.

FIG. 2 shows a schematic view of the various sensors, transducers and components disposed in the underside of the access cover of FIG. 1.

FIG. 3 is a schematic perspective view that illustrates how the monitoring access cover of FIG. 1 is seated inside a complementary-shaped surround when in use.

FIG. 4 is a cross-sectional view of the monitoring access cover of FIG. 1 positioned above a drain gully when in use, and also shows a high-level schematic illustration of a system which monitors and gathers information from a number of such access covers in accordance with the present invention.

FIGS. 5a and 5b show side perspective views from above and below, respectively, of a second embodiment and shows how the present invention can be embodied as a generally circular household drain cover.

FIGS. 6a and 6b are side perspective views from above and below, respectively, of a third embodiment and shows how the present invention can be embodied as a generally rectangular household drain cover.

FIGS. 7a and 7b illustrate side perspective views from above and below, respectively, of a third embodiment and shows how the present invention can be embodied as a water tank cover.

### DETAILED DESCRIPTION OF THE INVENTION

The present invention has adopted the approach of utilising an access cover or grate that is positioned over a drain gully and which can be used to monitor the level of the water and/or sediment in the drain gully. Advantageously, the sensed level of water and/or sediment in the drain gully is transmitted continuously or intermittently, in real time, or near real time, for the purposes of service, repair, cleaning and/or flood warning. Further advantageously, the transmitted data can be used to more efficiently and proactively manage the drainage assets of a sewer system network. Further advantageously, the present invention provides additional sensors and transducers disposed on the access cover that sense data representative of one or more environmental conditions and/or sensed parameters and/or other asset conditions. Localised information is gathered for dynamic and/or preventative action, reports and warning, such as, for example, total or partial removal of the access cover from the drain gully by vandals or by theft, and/or for warning when localised temperatures are sufficiently low enough to justify road gritting, etc. Further advantageously, the present invention provides an access cover or grate which is dimensioned as a retrofit product, or as a new installation with a complementary-shaped surround.

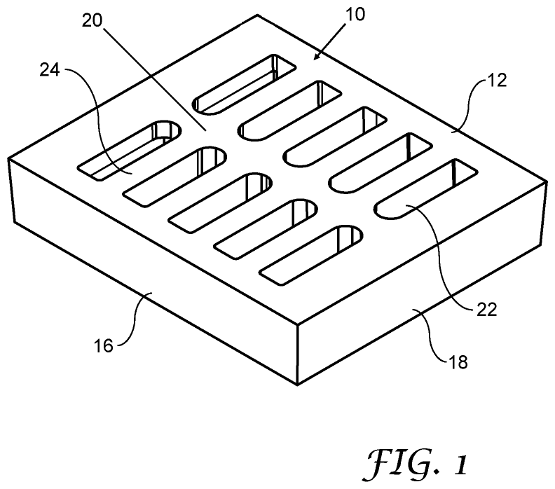

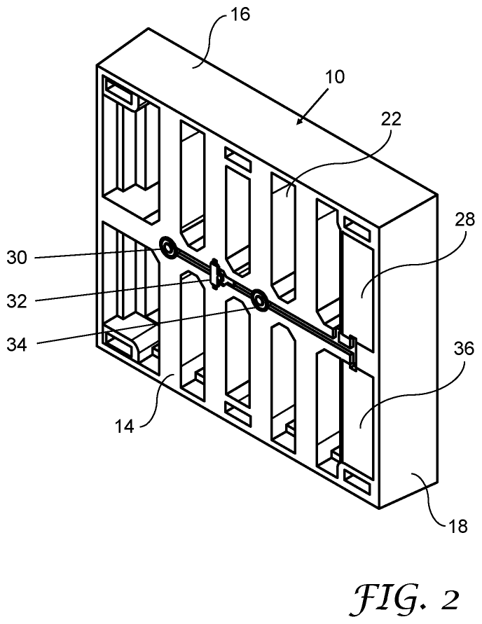

Referring now to the drawings, a monitoring access cover or grate 10 for roadside surface water drains and gullies according to the present invention is shown in FIGS. 1 and 2. The access cover or grate 10 is formed having a generally rectangular-shape in plan view with a top surface 12 and an opposite underside surface 14. Extending between the top 12 and bottom 14 surfaces are a pair of side walls 16. A pair of end walls 18 also extend therebetween.

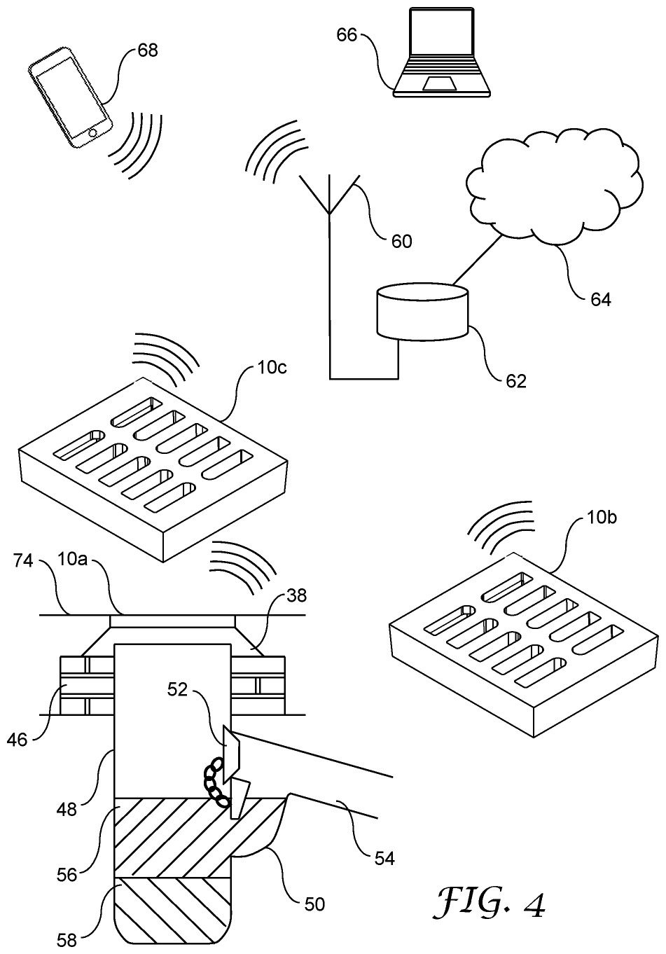

FIGS. 1 and 2 show that running through from the top surface 12 to the bottom surface 14 of the access cover 10 are two aligned rows of elongate apertures 22. The position of the rows of apertures 22 form a central longitudinal rib 20 which runs between the end walls 18, and a series of transverse ribs 24 which run between the side walls 16. It through the apertures 22 that surface water at the top surface 12 of the access cover 10 can pass into a drain gully cup 48 and into the sewer water system 54, as best shown in FIG. 4.

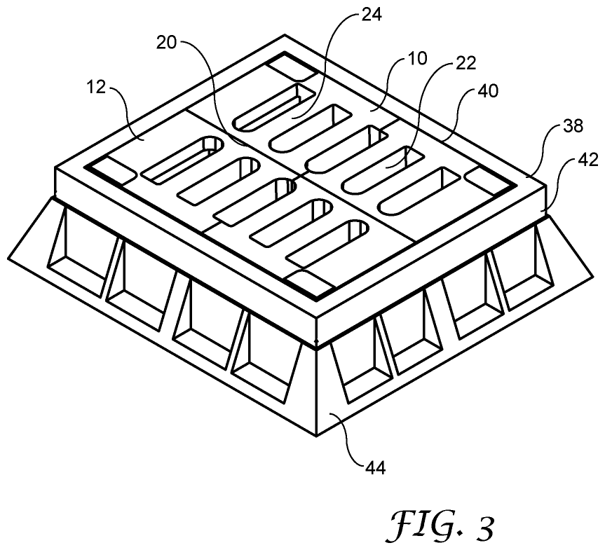

A textured anti-slip pattern (not shown) can be formed on the top surface 12 of the access cover 10. The skilled person will appreciate that the side walls 16 and end walls 18 are inclined inwardly towards the underside 14 of the access cover 10, as best shown in FIGS. 1 and 2 such that they can be received and retained with a close fit inside a grate surround 38, as shown in FIG. 3.

In a preferred embodiment, the material forming the access cover 10 is injection-moulded 50% glass fibre-filled polyamide. To ensure the necessary load bearing and mechanical strength defined by various British and European Standards, including European Standard EN 124:1994, the transverse ribs 24 which run between the side walls 16 can include steel reinforcing strips or rods (not shown).

The skilled person will appreciate that the cover 10 can be formed from any number of synthetic plastics material, such as a thermoplastic or thermoset material, or any other suitable first or second generation plastics material. The above list is in no way intended to be limiting and exhaustive.

The skilled person will appreciate that different variations or densities of materials could also be provided. Manufacturing the access cover 10 using injection moulding will allow for a generally low product weight which provides a good structural rigidity and durability. The cover 10 can be supplied in a number of different colours.

The cover 10 can be further manufactured using other techniques such as blow moulding, vacuum forming, rotational moulding, compression moulding, rim moulding, powder impression moulding or any other form of plastics manufacture. The cover 10 can be manufactured from a blend of recycled polymers from both post-industrial and domestic waste teams. In a preferred embodiment, the cover 10 can be manufacture having up to 50% by weight recycled polymer relative to the total polymer content. The amount of recycled polymer can be as high as 75% by weight relative to the total polymer content, or even 100% by weight recycled polymer relative to the total polymer content.

Alternatively, the access cover 10 can be formed from a cast iron material.

Disposed at the underside 14 of the access cover 10, and located generally at each corner thereof are a series of voids 26. Sealed into these voids 26 are one or more batteries 28 which are used to power the sensors of the intelligent, monitoring access cover 10. To preserve the life of the battery 28, the height of the water 56 and/or sediment 58 in the gully cup 48, as monitored by the access cover 10, can be made at regular intervals or, alternatively, the cover 10 can be awoken by physical movement of the access cover 10 and/or a rapid or marked change in the height of the water 56 and/or sediment 58 in the gully 48.

Also disposed at the underside 14 of the access cover 10, running along the central longitudinal rib 20, are a number of sensors and transducers, as set out below. A proximity sensor 30 which, in use, faces directly downward into the gully cup 48 (as also shown in FIG. 4) is provided. In use, the proximity sensor 30 looks for a time-of-flight return signal from the level of water 56 in the gully cup 48 to determine the height of the water 56.

A water sensor 32 is also provided at underside 14 of the access cover 10, running along the central longitudinal rib 20. The water sensor 32 can detect actual moisture across its contacts, and will sense when a condition when the water level 56 is at the top of the gully cup 48.

An infrared (IR) sensor 34 is also provided which can detect and discriminate the level of level of sediment or silt 58 in the bottom of the gully cup 48. This information is very useful for the purposes of cleaning and otherwise maintaining the drainage asset, as it is apparent from FIG. 4 that an accumulation of sediment 58 will inevitably prevent surface water from entering the sewer water system 54, and which could lead to localised flooding.

The skilled person will appreciate that each of the sensors 30, 32, 34 is a sealed unit with the necessary level of ingress protection for use in such challenging environments.

The output of the sensors 30, 32, 34 is connected to a processing and communications unit or module 36 situated in one of the voids 26 at the underside 14 of the gate 10. Additional sensors and transducers can also be included to provide additional functionality, as set out below. The processing and communications module 36 for remotely monitoring the drain gully 48 is implemented as low power microcontroller which receives a number of inputs from sensors 30, 32, 34. The microcontroller can be considered a self-contained system with a processor, memory and peripherals and can be used to output information to the end user via a number of outputs, as described below in FIG. 4.

The access cover 10, in use, can be retrofitted to an existing gully surround or can be used with its own complementary-shaped surround 38, as shown in FIG. 3. The surround 38 has an opening 40 into which the cover 10 can be retained by a close or interference fit and an upper peripheral lip 42 which is at the same level as the top surface 12 of the access cover 10 and the road surface 74. The surround 38 also has a base 44 which is externally tapered outwards to meet with the foundations 46 of the gully (as best shown in FIG. 4).

In a preferred embodiment, the surround 38 is formed from the same material as the access cover 10.

The operation of the access cover 10 of the present invention is best shown in FIG. 4. FIG. 4 shows that an individual access cover 10a is situated above the drain gully inside the surround 38 supported by courses of engineering brick 46. The gully or storm drain is entirely consistent with those known in the art and consists of a lined void or gully cup 48 which to retain silt and debris 58 and a trap 50 and a hood or stopper 52 which prevents debris entering the sewer water system 54. As water 56 fills the gully cup 48, debris and sediment 58 falls to the bottom of the gully cup 48 and the water 56 (being free of floatables and debris) is able to flow into the sewer water system 54. The skilled person will appreciate that if the sediment or silt 58 at the bottom of the gully cup 48 accumulates, it can block the trap 50 and enter the sewer water system 54 through its stoppered or guarded opening 52. This, of course, is undesirable.

The access cover 10a of the present invention can be used to interrogate the height of the water 56 in the gully 48 using proximity sensor 30, and the height of the sediment 58 using IR sensor 34. As a “fail safe”, the underside 14 of the access cover 10 includes a water sensor 32 that is activated when the height of the water 56 physically reaches it, and which closes its electrical contacts.

Information from the sensors 30, 32, 34 being passed to the processor and communications module 36 which is able to communicate information wirelessly via a receiving aerial 60 to a server 62. The server 62 is connected to the Internet 64.

Information about each of the access covers 10a, 10b, 10c, etc. as monitored by the system can be accessed via a remote application software or user interface embodied on a remote computing device 66 or mobile communications device 68 which is uniquely connected to the server 62. The application software can be downloaded to the mobile communications device 68 via known digital media platforms, such as, for example, the App Store for iOS-enabled devices and Google Play for touchscreen mobile devices based on the Android operating system.

In the embodiment shown in FIG. 4, the remote computing device 66 or mobile communications device 68 is connected to the server 62 via the Internet 64. The skilled person will appreciate that other wireless transmission protocols, such as, for example, Wi-Fi (IEEE 802.11 standard), Bluetooth, LoRa, Sigfox or a GSM cellular telecommunications network would also be appropriate, or the remote computing device 66 could be connected to the server 62 via a wired connection.

As shown in FIG. 4, a plurality of such access covers 10a, 10b, 10c, etc. are all monitored by the single server 62, with the information from each of access covers 10a, 10b, 10c being accessible by a user having unique login credentials, as is known to someone skilled in the art. The application software may also include a map function having the physical location of each of the access covers 10a, 10b, 10c overlaid thereon.

The value such information, which is transmitted continuously or intermittently, in real time, or near real time, from each of the access covers 10a, 10b, 10c, etc., and remotely accessing and retrieving such information can be extremely useful. In effect it allows for the cleaning and/or maintenance of the drainage assets to be managed more efficiently; saving costs, resources and manpower.

The application software or user interface embodied on a remote computing device 66 or mobile communications device 68 can be programmed to provide a constant reading of the water 56 and sediment 58 levels of each gully cup 48 allowing the user or operator to know which requires, or does not require, action. The application software can be programmed to alert or warn users that certain gullies require cleaning out. The present invention can warn for potential problems such as, but not just limited to, overflows and blockages, and allows for dynamic and targeted maintenance and servicing of drainage assets.

By measuring the height of the water and/or sediment in the drain gully cup 48 over time, the present invention can therefore measure the flow of water entering and exiting each of the access covers 10a, 10b, 10c, etc.

The access cover 10 is designed to have a three-year battery life depending on frequency of use and/or activity.

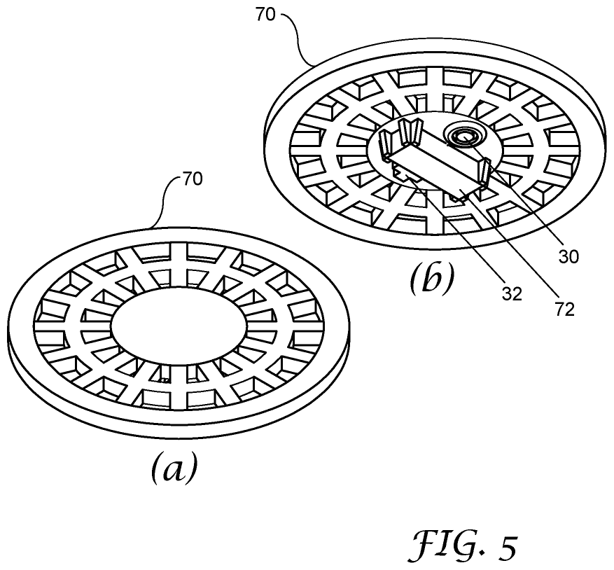

FIGS. 5a and 5b show a second embodiment of the access cover 10. The construction of the second embodiment is very similar to that of the first embodiment and corresponding features have been given the same reference numerals. The second embodiment differs from the first embodiment in that the access cover 70 is configured having a generally circular shape for use in monitoring household or domestic water drainage systems. FIG. 5b shows that the underside of the access cover 70 can particularly, but not exclusively, include a proximity sensor 30 and water sensor 32 connected to a sealed enclosure 72 which contains the processing and communications modules and battery.

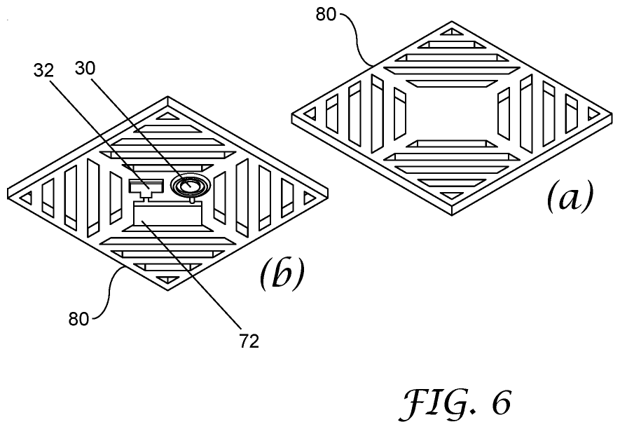

FIGS. 6a and 6b show a third embodiment of the access cover 10. The construction of the third embodiment is very similar to that of the first and second embodiments and corresponding features have been given the same reference numerals. The third embodiment differs from the first and second embodiments in that the access cover 80 is configured having a generally rectangular shape for use in monitoring household or domestic water drainage systems. FIG. 6b shows that the underside of the access cover 80 can particularly, but not exclusively, include a proximity sensor 30 and water sensor 32 connected to a sealed enclosure 72 which contains the processing and communications modules and battery.

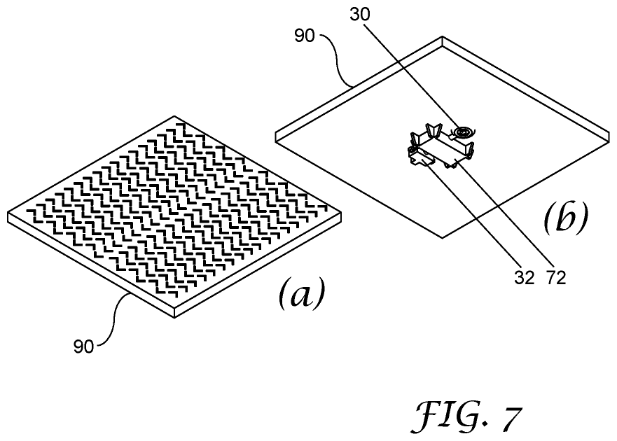

FIGS. 7a and 7b shows a fourth embodiment of the access cover 10. The construction of the fourth embodiment is very similar to that of the first, second and third embodiments and corresponding features have been given the same reference numerals. The fourth embodiment differs from the first, second and third embodiments in that instead in that the access cover 90 is configured as a tank cover for use in monitoring levels in tanks and vessels. FIG. 7b shows that the underside of the access cover 90 can particularly, but not exclusively, include a proximity sensor 30 and water sensor 32 connected to a sealed enclosure 72 which contains the processing and communications modules and battery.

Various additions and alternations may be made to the present invention. For example, although particular embodiments refer to implementing the present invention with roadside surface water drains and gullies, this is in no way intended to be limiting as, in use, the present invention can be implemented with any number of drainage and sewer water systems, and processing tanks and vessels.

The invention is not intended to be limited to the details of the embodiments described herein, which are described by way of example only. It will be understood that features described in relation to any particular embodiment can be featured in combination with other embodiments.

It is contemplated by the inventor that various substitutions, alterations, and modifications may be made to the invention without departing from the spirit and scope of the invention as defined by the claims. Examples of these include the following:

The access cover 10 can also include additional sensors and transducers. In particular, the access cover 10 can also include a Global Positioning Sensor (GPS) tracker which can automatically report the position of the access cover 10 to the server 62. This is particular useful in the event of removal of the access cover 10 by vandals or by theft. Alternatively, the orientation and position and/or removal of the access cover 10 from the surround 38 can be monitored by sensing the output of a three-axis accelerometer embedded in the access cover 10.

The access cover 10 can also include a temperature sensor and therefore can inform of the weather local to the cover 10. This environmental information can be used to accurately gauge whether there is need to lay grit, for example, for icy conditions.

In an alternative embodiment, ultrasonic sensors can be included for more difficult measuring scenarios. In addition, a separate strain gauge could be placed at the base of the gully cup 48 and which communicates with the communications unit 26 wirelessly to directly measure the weight of water and sediment in the gully cup 48.

The cover 10 can also include a wireless transceiver and act as a Wi-Fi hotspot for hard-to-reach telecommunication areas.

The surround 38 and or the cover 10 may also include an upwardly-projecting LED warning light which can be energised in the event that the access cover 10 is removed from the surround 38, and thereby providing a hazard warning to road users.

The security applications of the present invention are also hugely important. In effect, the present invention can be programmed to alert or notify a user if the access cover 10 is removed and/or if the height of the water and/or sediment in a drain gully changes. If explosives, or an improvised explosive device, is placed inside the drain gully cup 48, then this will be detectable by the access cover 10.

The above list is in no way intended to be limiting and exhaustive.

1-4. (canceled)

5. The access cover, comprising:
a flat top surface and a spaced apart bottom surface;
a pair of side walls which extend between the top and bottom surfaces;
a pair of end walls which extend between the top and bottom surfaces; and
a plurality of apertures disposed in the top surface and the bottom surface, and through which water can pass.

6. The access cover as claimed in claim 5, wherein the access cover is formed having a generally rectangular-shape in plan view and in use is positioned in a generally horizontal configuration with the top surface being uppermost.

7. The access cover as claimed in claim 5, wherein the plurality of apertures being formed as two aligned rows of elongate apertures positioned between the side walls.

8. The access cover as claimed in claim 7, wherein the two aligned rows of elongate apertures form or define a central longitudinal rib positioned between the end walls.

9. The access cover as claimed in claim 5, wherein the side walls and end walls are inclined inwardly towards the underside of the access cover, such that the access cover can be received and retained with a close fit inside a surround fixed above the drain gully.

10.-16. (canceled)

17. The access cover as claimed in claim 8, wherein the one or more sensors are disposed along the central longitudinal rib at the underside of the access cover.

18. The access cover as claimed in claim 1, wherein the one or more sensors comprises a proximity sensor which, in use, faces downwardly into the drain gully and which generates an output signal based on the height of the water in the drain gully.

19. The access cover as claimed in claim 1, wherein the one or more sensors comprises a water sensor which, in use, generates an output signal when the height of the water in the drain gully physically contacts the water sensor.

20. The access cover as claimed in claim 1, wherein the one or more sensors comprises an infrared sensor which, in use, faces downwardly into the drain gully and which generates an output signal based on the level of sediment or silt in the drain gully.

21. The access cover as claimed in claim 1, wherein the one or more sensors is selected from the group consisting of photodiode, photoresistor, photodetector, resistance temperature detector, thermocouple, thermistor, piezoelectric, potentiometer, strain gauge, air flow sensor, anemometer, microphone, proximity sensor, motion sensor, Hall effect sensor, accelerometer, ultrasonic sensor, GPS tracker.

22. The access cover as claimed in claim 1, wherein the one or more sensors are sealed inside ingress protected enclosures.

23. The access cover as claimed in claim 1, further comprising:
a battery disposed in the underside of the access cover; and
processing and communications module for transmitting the sensed output signals.

24. The access cover as claimed in claim 23, wherein the processing and communications module is implemented as a low power microcontroller.

25-26. (canceled)

27. The access cover as claimed in claim 23, further comprising server means for sharing the received data with one or more remote computing devices over a network.

28. The access cover as claimed in claim 27, wherein the remote computing device comprises a user interface for displaying and/or consuming the processed data.

29. The access cover as claimed in claim 23, wherein the central processing means comprises associated backend software.

30-31. (canceled)

32. A method of remotely monitoring a drain gully, comprising the steps of:
providing an access cover or grate comprising one or more sensors disposed at the underside thereof to measure the height of the water and/or sediment in a drain gully;
allocating a unique identifier to the access cover;
monitoring the height of the water and/or sediment in the drain gully;
communicating the measured height of the water and/or sediment to a central server; and
providing user access to the central server.

33. A system to monitor a drain gully, comprising:
central server means;
a uniquely identifiable remote sensing device disposed on an access cover including a processing means for receiving one or more sensed outputs representative of one or more environmental conditions and/or asset conditions; and
user interface means in wireless communication with the central server means, the user interface means being operable by a user for displaying the one or more sensed outputs.
